(19) United States
(12) Patent Application Publication
(10) Pub. No.: US 2005/0073747 A1
(43) Pub. Date: Apr. 7, 2005

(54) Diffractive optical element, manufacturing method thereof, optical pickup apparatus and optical disk drive apparatus

(76) Inventor: Tsuyoshi Suzudo, Miyagi (JP)

Correspondence Address: DICKSTEIN SHAPIRO MORIN & OSHINSKY LLP, 2101 L Street, NW, Washington, DC, 20037, US

(21) Appl. No.: 10/402,968

(22) Filed: Apr. 1, 2003

(30) Foreign Application Priority Data
Apr. 9, 2002 (JP) 2002-106444

(51) Int. Cl. G02B 5/18; G02B 27/44

(52) U.S. Cl. 359/566; 359/569

(57) ABSTRACT

A diffractive optical element improves wavefront aberration for transmitted light. The diffractive optical element includes first and second substrates, an adhesive layer, a film, and an overcoat layer, all of which are formed of optically transparent materials. The film is glued on the first substrate via the adhesive layer. The film has a surface where a desired diffraction grating is formed in accordance with an irregularity thereof. The overcoat layer is formed on the film surface so as to fill a concave part of the diffractive grating. The second substrate is glued on the overcoat layer so as to make plane a surface of the overcoat layer. The adhesive layer and the film have an approximately equal refractive index.

### BACKGROUND OF THE INVENTION

1. Field of the Invention

The present invention generally relates to a diffractive optical element, a manufacturing method thereof, an optical pickup apparatus and an optical disk drive apparatus.

2. Description of the Related Art

A diffractive optical element is an optical element for causing desired diffraction for given light. Such a diffractive optical element is widely used as a spectral element and a deflection element.

Conventionally, various diffractive optical elements have been proposed. Japanese Laid-Open Patent Applications No. 2000-221325 and No. 2000-075130 disclose diffractive optical elements capable of forming desired diffraction gratings. These diffractive optical elements are formed by providing an organic film or a polymer film on an optically transparent substrate and can provide the desired diffraction gratings through an irregularity of the film surface.

However, the diffractive optical elements have a problem in that there arises degradation (increase) of wavefront aberration of transmitted light if the substrate or an adhesive layer for gluing the film on the substrate does not have uniform thickness.

The above-mentioned conventional diffractive optical elements work as polarization holograms whose film has a birefringence property. In an optical pickup apparatus, for instance, the conventional diffractive optical element is preferably used for light path separation into light from an illuminant and luminous flux reflected on an optical disk. Here, if the wavefront aberration is degraded for transmitted light from the illuminant, it becomes difficult to form an optical spot of a desired spot diameter on the recording surface of the optical disk using the transmitted light.

### SUMMARY OF THE INVENTION

It is a general object of the present invention to provide a diffractive optical element, a manufacturing method thereof, an optical pickup apparatus and an optical disk drive apparatus in which the above-mentioned problems are eliminated.

A more specific object of the present invention is to provide a novel and useful diffractive optical element that can effectively suppress degradation of wavefront aberration for transmitted light and a manufacturing method thereof.

Another more specific object of the present invention is to provide an optical pickup apparatus and an optical disk drive apparatus wherein the above-mentioned diffractive optical element is effectively used therein.

In order to achieve the above-mentioned objects, there is provided according to one aspect of the present invention a diffractive optical element manufacturing method, comprising the steps of: gluing an optically transparent film on a first optically transparent substrate via an optically transparent adhesive layer; forming a desired diffraction grating by an irregularity of a surface of the film glued; forming an overcoat layer of an optically transparent adhesive on the surface of the film where the desired diffraction grating is formed such that the adhesive fills a concave part of the diffraction grating; and gluing a second optically transparent substrate on the overcoat layer such that a surface of the overcoat layer is made plane, wherein the adhesive layer and the film have an approximately equal refractive index.

In the above-mentioned diffractive optical element manufacturing method, the adhesive layer and the overcoat layer may be formed of an adhesive of a photo-curing resin so that the adhesive layer and the overcoat layer can be glued by solidification due to light radiation.

In the above-mentioned diffractive optical element manufacturing method, the optically transparent film may be a birefringent film and the adhesive layer may have a refractive index approximately equal to one of refractive indexes of the film with respect to an ordinary light ray and an extraordinary light ray.

In the above-mentioned diffractive optical element manufacturing method, the overcoat layer may have a refractive index approximately equal to one of refractive indexes of the film with respect to an ordinary light ray and an extraordinary light ray.

In the above-mentioned diffractive optical element manufacturing method, the optically transparent film may be formed of an organic material having a birefringence property.

In the above-mentioned diffractive optical element manufacturing method, the optically transparent film may be provided with a birefringence property by extension thereof.

In the above-mentioned diffractive optical element manufacturing method, the adhesive layer and the overcoat layer may be formed of an adhesive of a same material.

Additionally, there is provided according to another aspect of the present invention a diffractive optical element, comprising: a first optically transparent substrate; an optically transparent adhesive layer; an optically transparent film being glued on the first optically transparent substrate via the optically transparent adhesive layer, the optically transparent film having a surface wherein a desired diffraction grating is formed by an irregularity thereof; an overcoat layer being formed of an optically transparent adhesive on the surface wherein the desired diffraction grating is formed such that the adhesive fills a concave part of the diffraction grating; and a second optically transparent substrate being formed on the overcoat layer such that a surface of the overcoat layer is made plane, wherein the adhesive layer and the film have an approximately equal refractive index.

In the above-mentioned diffractive optical element, the optically transparent film may be a birefringent film and the adhesive layer may have a refractive index approximately equal to one of refractive indexes of the film with respect to an ordinary light ray and an extraordinary light ray.

Additionally, the above-mentioned diffractive optical element further may comprise an entrance surface and/or an exit surface that are/is antireflection coated.

Additionally, there is provided according to another aspect of the present invention an optical pickup apparatus for performing at least one of an information recording process, an information reproducing process, and an information deleting process by concentrating light emitted from an illuminant as an optical spot on a recording surface of an optical disk via an objective lens and directing a luminous flux reflected on the recording surface to a light detecting part via the objective lens, comprising: a diffractive optical element being provided between the illuminant and the objective lens, the diffractive optical element comprising: a first optically transparent substrate; an optically transparent adhesive layer; an optically transparent film being glued on the first optically transparent substrate via the optically transparent adhesive layer, the optically transparent film having a surface wherein a desired diffraction grating is formed by an irregularity thereof; an overcoat layer being formed of an optically transparent adhesive on the surface wherein the desired diffraction grating is formed such that the adhesive fills a concave part of the diffraction grating; and a second optically transparent substrate being formed on the overcoat layer such that a surface of the overcoat layer is made plane, wherein the adhesive layer and the film have an approximately equal refractive index.

In the above-mentioned optical pickup apparatus, the optically transparent film may be a birefringent film, the adhesive layer may have a refractive index approximately equal to one of refractive indexes of the film with respect to an ordinary light ray and an extraordinary light ray, and the diffractive optical element may be used as a polarization hologram element for splitting the luminous flux toward the optical detecting part through diffraction.

In the above-mentioned optical pickup apparatus, the diffractive optical element may have an illuminant side surface and/or an objective lens side surface that are/is antireflection-coated.

Additionally, there is provided according to another aspect of the present invention an optical disk drive apparatus for performing at least one of an information recording process, an information reproducing process, and an information deleting process, comprising: an optical pickup apparatus concentrating light emitted from an illuminant as an optical spot on a recording surface of an optical disk via an objective lens and directing a luminous flux reflected on the recording surface to a light detecting part via the objective lens, the optical pickup apparatus comprising: a diffractive optical element being provided between the illuminant and the objective lens, the diffractive optical element comprising: a first optically transparent substrate; an optically transparent adhesive layer; an optically transparent film being glued on the first optically transparent substrate via the optically transparent adhesive layer, the optically transparent film having a surface wherein a desired diffraction grating is formed by an irregularity thereof; an overcoat layer being formed of an optically transparent adhesive on the surface wherein the desired diffraction grating is formed such that the adhesive fills a concave part of the diffraction grating; and a second optically transparent substrate being formed on the overcoat layer such that a surface of the overcoat layer is made plane, wherein the adhesive layer and the film have an approximately equal refractive index.

In the above-mentioned optical disk drive apparatus, the optically transparent film may be a birefringent film, the adhesive layer may have a refractive index approximately equal to one of refractive indexes of the film with respect to an ordinary light ray and an extraordinary light ray, and the diffractive optical element may be used as a polarization hologram element for splitting the luminous flux toward the optical detecting part through diffraction.

In the above-mentioned optical disk drive apparatus, the diffractive optical element may have an illuminant side surface and/or an objective lens side surface that are/is antireflection-coated.

According to the above-mentioned inventions, it is possible to provide a diffractive optical element that can suppress degradation of wavefront aberration of transmitted light. If such a diffractive optical element is used in an optical pickup apparatus, it is possible to properly form an optical spot of a desired spot diameter on a recording surface of an optical disk. Furthermore, if such an optical pickup apparatus is used in an optical disk drive apparatus, it is possible to reproduce, record and delete information in the optical disk.

Other objects, features and advantages of the present invention will become more apparent from the following detailed description when read in conjunction with the accompanying drawings.

### BRIEF DESCRIPTION OF THE DRAWINGS

FIG. 1 is a cross-sectional view of a diffractive optical element according to the present invention;

FIG. 2 is a diagram illustrating an optical structure of an optical pickup apparatus according to the present invention;

FIG. 3 is a block diagram illustrating a structure of an optical disk drive apparatus according to the present invention; and

FIG. 4 is a cross-sectional view of a diffractive optical element according to the present invention for explaining improvement (reduction) of wavefront aberration.

### DETAILED DESCRIPTION OF THE PREFERRED EMBODIMENTS

In the following, embodiments of the present invention will be described with reference to the accompanying drawings.

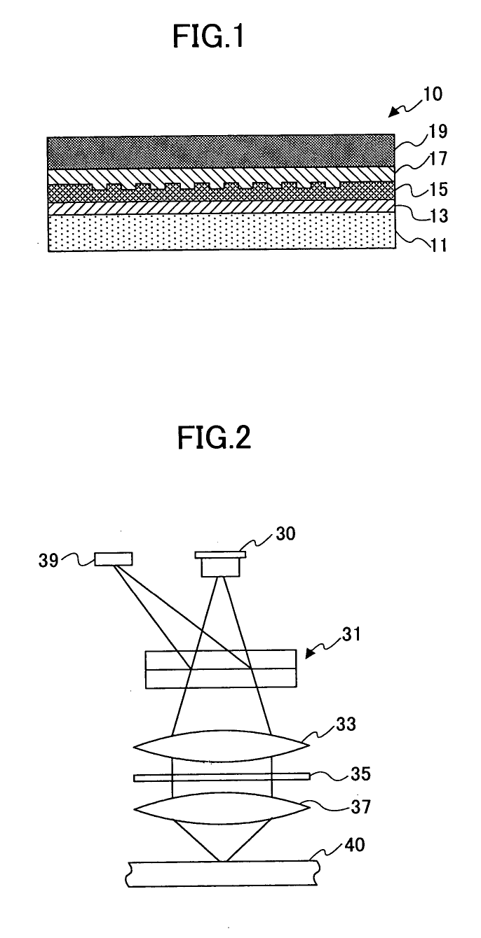

FIG. 1 is a cross-sectional view of a diffractive optical element according to the present invention.

In FIG. 1, a diffractive optical element 10 comprises a first optically transparent substrate 11, an adhesive layer 13, an optically transparent film 15, an overcoat layer 17, and a second optically transparent substrate 19.

The first substrate 11 and the second substrate 19 are arranged as parallel flat planes. Namely, the first substrate 11 and the second substrate 19 are aligned in parallel with each other with high accuracy and are shaped as precise flat planes. The first and the second substrates 11 and 19 may be preferably formed of a variety of optical glasses, typically, BK7.

An adhesive constituting the adhesive layer 13 and the overcoat layer 19 can be formed of an epoxy resin, in particular, a photo-curing resin.

The optically transparent film 15 can be formed of a polyester organic material. If such an organic material is extended as the film 15, it is possible to provide a birefringence property to the film 15.

A description will be given of a manufacturing method of the diffractive optical element 10.

First, the film 15 is glued on the first optically transparent substrate 11 via the optically transparent adhesive layer 13. When convex-concave irregularity is provided on a surface of the film 15, it is possible to obtain a diffraction grating in accordance with the irregularity. If appropriate irregularity is designed corresponding to a desired diffraction grating, it is possible to form not only an ordinary 1st-order diffraction grating but also a diffraction grating that can provide multiple-lens effect or astigmatism to diffracted light. It is possible to easily form such a diffraction grating through photolithography and etching.

For instance, after a thin metal film is sputtered on a surface of the film 15 on which such a diffraction grating is formed and a photoresist is provided on the thin metal film, the photoresist is exposed and developed in accordance with a pattern of the diffraction grating to be formed. If an exposed portion of the thin metal film and the photoresist are removed, it is possible to obtain a mask of the thin metal film on the film 15 corresponding to the diffraction grating pattern. Then, if the film 15 is anisotropically etched via the obtained mask, the diffraction grating is formed corresponding to the mask. After that, if the thin metal film mask is removed through liftoff, it is possible to obtain the expected diffraction grating in accordance with the irregularity of the surface of the film 15.

Next, the overcoat layer 17, which is formed of an optically transparent adhesive, is provided on the surface of the film 15 where the diffraction grating is formed such that the adhesive fills a concave part of the diffraction grating. Then, the second optically transparent substrate 19 is glued on the overcoat layer 17 such that the surface of the overcoat layer 17 is made plane.

As mentioned above, it is possible to obtain the diffractive optical element 10 according to the present invention.

The diffractive optical element 10 includes the adhesive layer 13 and the film 15 whose refractive indexes are approximately equal to each other.

Here, when the film 15 is a birefringence film, the adhesive layer 13 whose refractive index is approximately equal to one of refractive indexes of the film 15 with respect to an ordinary light ray and an extraordinary light ray is adopted in the diffractive optical element 10. In this case, the overcoat layer 17 may also have a refractive index approximately equal to one of refractive indexes of the film 15 with respect to an ordinary light ray or an extraordinary light ray. When the adhesive layer 13 and the overcoat layer 17 are formed of the same adhesive, it is possible to easily realize such a structure.

Furthermore, the entrance surface and/or the exit surface of the diffractive optical element 10 may be antireflection-coated.

A description will now be given, with reference to FIG. 2, of an optical pickup apparatus using the above-mentioned diffractive optical element.

FIG. 2 is a diagram illustrating the optical structure of the optical pickup apparatus.

In this optical pickup apparatus, light from an illuminant 30 is concentrated as an optical spot on a recording surface of an optical disk 40 by an objective lens 37. Luminous flux reflected on the recording surface is guided to a light detecting part 39 via the objective lens 37. The optical pickup apparatus records, reproduces or deletes information for the optical disk 40. In this optical pickup apparatus, a diffractive optical element 31 according to the present invention is provided between the illuminant 30 and the objective lens 37.

Here, the diffractive optical element 31 has a structure similar to the above-mentioned diffractive optical element 10.

In the optical pickup apparatus shown in FIG. 2, light emitted from a semiconductor laser as the illuminant 30 is transmitted through the diffractive optical element 31. In this case, the diffractive optical element 31 is used as a polarization hologram element. The light from the illuminant 30 is transmitted through the diffractive optical element 31 and then is collimated by a collimater lens 33.

The collimated light is transmitted through a ¼ wavelength plate 35 and then is concentrated as an optical spot on the recording surface of the optical disk 40 by the objective lens 37. Luminous flux reflected on the recording surface is transmitted through the objective lens 37 and the ¼ wavelength plate 35. Then, the luminous flux becomes a linear polarization whose polarization surface is rotated by 90° with respect to the original direction. The linear polarization light enters the diffractive optical element 31 and is deflected to the light detecting part 39 through diffraction by the diffractive optical element 31. At this time, for instance, if astigmatism is provided to the reflected light by the diffractive optical element 31 and the light detecting part 39 receives the reflected light, it is possible to generate a focusing signal by an astigmatism method and a tracking signal or a reproducing signal by a push-pull method.

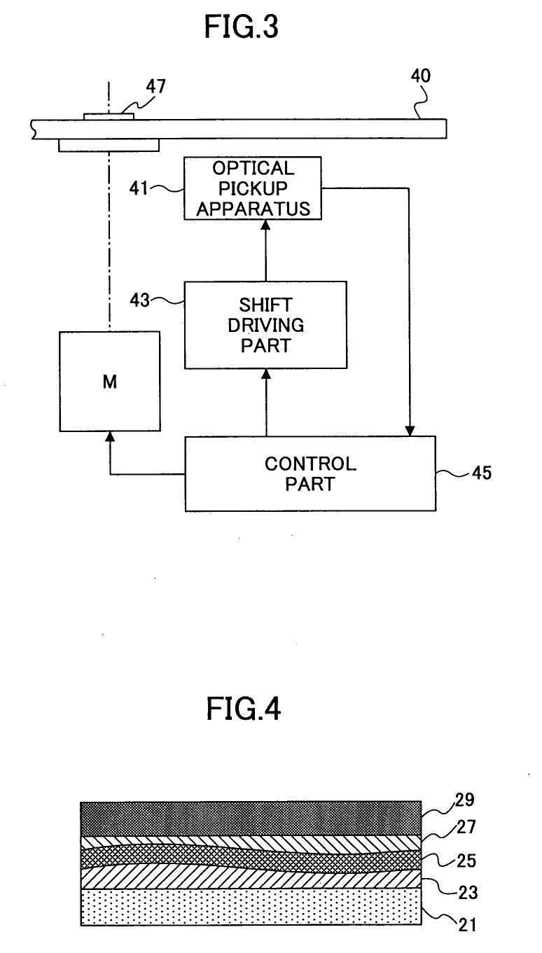

A description will now be given, with reference to FIG. 3, of an optical disk drive apparatus using the above-mentioned optical pickup apparatus.

FIG. 3 is a block diagram illustrating the structure of an optical disk drive apparatus according to the present invention.

The optical disk drive apparatus shown in FIG. 3 records, reproduces or deletes information in an optical disk 40 by using an optical pickup apparatus 41 according to the present invention. The optical disk 40 is retained by a retaining part 47 and is rotated by a motor M as a driving part.

The optical pickup apparatus 41 is shifted in the radial directions of the optical disk 40 by a shift driving part 43 and then records, reproduces or deletes information in the optical disk 40. A control part 45 controls not only various operations based on signals from the optical pickup apparatus 41 and an output of a reproduction signal but also the whole optical disk drive apparatus.

A supplemental description will now be given of the above-mentioned diffractive optical element.

When the diffractive optical element as shown in FIG. 1 is used in the above-mentioned optical pickup apparatus, the diffractive optical element is required to be reduced in size thereof to a few square milimeters. In fabrication of such a diffractive optical element, hundreds of the diffractive optical elements are fabricated at one time rather than one piece by one piece fabrication.

In detail, the first and the second substrates, whose diameters have several dozen milimeters through several hundred milimeters, are used in the fabrication. For instance, it is supposed that the substrates have the diameter of 100 mm or 160 mm. In this configuration, an adhesive layer is provided on the first substrate. There are some forming methods of the adhesive layer. As an example, a spin coating method using a spin coater can be preferably used in this case.

A film slightly smaller than the substrate is provided on the adhesive layer such that the film is glued on the first substrate via the adhesive layer. Here, when a photo-curing material, for instance, an ultraviolet-curing resin, is used as the adhesive, the film is provided on an adhesive layer that has not been cured. Then, ultraviolet light is radiated on the adhesive layer via the film. As a result, it is possible to glue the film through solidification of the adhesive layer.

In this case, it is necessary to strengthen the adhesive force so that the film cannot be released from the first substrate in subsequent fabrication processes. For this reason, it is preferable to roughen the adhesive layer surface of the film. The surface may be roughened by performing a plasma process, a corona discharge or a sandblast process. Here, if an irregularity is too largely formed on the film through the roughness process, light is scattered. Therefore, it is necessary to design the irregularity such that the irregularity not only becomes smaller than λ/10 for a used wavelength λ but also effectively works to strengthen the adhesive force.

Additionally, diffraction gratings are simultaneously formed for a plurality of elements on the film surface glued on the substrate. If the diffraction gratings are formed through the above-mentioned photolithography and etching, it takes only several tens of seconds through a few minutes to perform the etching process. Therefore, it is possible to efficiently form the diffraction gratings.

Here, if a photoresist is pre-baked at about 100° C., the first substrate is warped by heat contraction of the film. For this reason, it is preferable to pre-bake the photoresist at a temperature lower than 60° C. Furthermore, if the photoresist is pre-baked under low pressure, it is possible to effectively remove the solvent at a low temperature of about 20° C. and accomplish the pre-baking process in a short time.

After the diffraction gratings are formed, the adhesive is coated on the entire film surface so as to form the overcoat layer. Then, the second substrate is glued to the overcoat layer so as to integrate all the parts. For instance, if an ultraviolet curing resin is used as the adhesive between the overcoat layer and the second substrate, the second substrate is provided after the coating of the adhesive. Then, when ultraviolet light is radiated on the overcoat layer via the second substrate, it is possible to cure the overcoat layer.

Here, it is preferable to roughen the overcoat surface of the film like the roughening process for the adhesive layer surface of the film.

After the second substrate is glued, it is possible to obtain individual diffractive optical elements by dicing the resulting product by means of a dicing saw.

A description will now be given of a diffractive optical element according to a first embodiment of the present invention.

In this diffractive optical element, a first substrate (S1) is formed of a parallel flat glass that is 100 mm in diameter and 1 mm in thickness. An adhesive layer (AL) of thickness 40 μm, which is formed of an epoxy adhesive, is provided on one surface of the first substrate. A film (F) of thickness 100 μm, which is formed of an organic polyester material, is glued on the adhesive layer.

A plurality of groups of desired diffraction gratings are formed on the film. Each group comprises uniform diffraction gratings each of which has the pitch 2 μm, the duty 50% and the depth 1 μm and is wedge-shaped with respect to a cross-section thereof. If the whole product is diced by means of a dicing saw in this configuration, it is possible to obtain diffractive optical elements of 5 mm×5 mm. Here, two types of such diffractive optical elements are prepared as samples.

It is supposed that the first substrate has the refractive index 1.52 for light of the wavelength 660 nm.

In a diffractive optical element according to the first sample (sample 1), an adhesive whose refractive index N=1.52 for light of the wavelength 660 nm is used as the adhesive layer of the sample 1. A film whose refractive index N=1.58 for light of the wavelength 660 nm is used as the film of the sample 1.

In a diffractive optical element according to the second sample (sample 2), an adhesive whose refractive index N=1.58 for light of the wavelength 660 nm is used as the adhesive layer of the sample 2. A film whose refractive index N=1.58 for light of the wavelength 660 nm is used as the film of the sample 2. Namely, the adhesive layer and the film have the same refractive index in the sample 2. RMSs (Root Mean Square) of wavefront aberration (WA) were measured for the samples 1 and 2 by using a measuring instrument Zygo MARK W. The following measurement results were obtained.

| | S1 N | AL N | F N | WA (λ rms) |
|---|---|---|---|---|
| sample 1 | 1.52 | 1.52 | 1.58 | 0.06-0.12 |
| sample 2 | 1.52 | 1.58 | 1.58 | 0.04-0.08 |

Here, the RMSs of the wavefront aberration have ranges as provided above in that a plurality of samples were measured for each of the two types of samples 1 and 2 and the measurement results of the samples are presented in the table.

From the measurement results, when the adhesive layer and the film have the same refractive index, it can be observed that the wavefront aberration is improved (reduced).

Next, a diffractive optical element according to the third sample (sample 3) is produced from the sample 2. Before the sample 2 is diced by means of a dicing saw, the overcoat (OC) layer of thickness 50 μm, which is formed of an adhesive of refractive index N=1.47, is provided on a film where a diffraction grating is formed. At this time, the concave part of the diffraction grating is filled with the adhesive. Then, when the resulting product is diced by means of a dicing saw, it is possible to obtain the sample 3 of 5 mm×5 mm.

RMSs of the wavefront aberration were measured for the sample 3 by using the measuring instrument Zygo MARK W. The following measurement result was obtained.

| | | | | | WA |
|---|---|---|---|---|---|
| | S1 N | AL N | F N | OC N | (λ rms) |
| sample 3 | 1.52 | 1.58 | 1.58 | 1.47 | 0.02-0.06 |

From the measurement result, if the adhesive layer and the film have the same refractive index and the overcoat layer is further provided on the film, it is possible to improve the wavefront aberration. However, the improved RMS of the wavefront aberration still reaches 0.06 at the upper bound. Here, even if the adhesive layer of the refractive index 1.52 is used in the sample 3, the same result as the sample 3 is obtained.

Next, a diffractive optical element according to the fourth sample (sample 4) is produced from the sample 3. Before the sample 3 is diced by means of a dicing saw, the second substrate (S2), which is formed of a parallel flat glass of the thickness 1 mm of BK7, is glued on the overcoat layer such that the overcoat layer is made plane. Then, when the resulting product is diced by means of a dicing saw, it is possible to obtain the sample 4 of 5 mm×5 mm.

RMSs of the wavefront aberration were measured for the sample 4 by using the measuring instrument Zygo MARK W. The following measurement result was obtained.

| | S1 N | AL N | F N | OC N | S2 N | WA (λ rms) |
|---|---|---|---|---|---|---|
| sample 4 | 1.52 | 1.58 | 1.58 | 1.47 | 1.52 | 0.01-0.02 |

From the measurement result, if the overcoat layer is provided on the adhesive layer and the film having the same refractive index, and the second substrate is further glued on the overcoat layer such that a surface of the overcoat layer is made plane, it is possible to further improve the wavefront aberration. Additionally, the improved wavefront aberration achieves an RMS whose deviation is smaller.

Here, the samples 3 and 4 also have the diffraction grating that has the pitch 2 μm, the duty 50% and the depth 1 μm and is wedge-shaped with respect to a cross-section thereof. The samples 1 through 4 have diffraction efficiency 10% and transmission factor 80% for light of the wavelength 660 nm.

A description will now be given of a diffractive optical element according to another embodiment of the present invention.

In this diffractive optical element, a first substrate (S1) is formed of a parallel flat glass of BK7 that is 100 mm in diameter and 1 mm in thickness. An adhesive layer (AL) of thickness 40 μm, which is formed of an epoxy adhesive, is provided on one surface of the first substrate. A film (F) of thickness 100 μm, which is formed of an organic polyester material, is further glued on the adhesive layer. When the film is extended, it is possible to provide the film with a birefringent property.

A plurality of groups of desired diffraction gratings are formed on the film. Each group comprises uniform diffraction gratings each of which has the pitch 2 μm, the duty 50% and the depth 4 μm and is wedge-shaped with respect to a cross-section thereof. If the resulting product is diced by means of a dicing saw in this configuration, it is possible to obtain diffractive optical elements (polarization hologram elements) of 5 mm×5 mm. Here, two types of such diffractive optical elements are prepared as samples.

It is supposed that the first substrate has the refractive index 1.52 for light of the wavelength 660 nm.

In a diffractive optical element according to the fifth sample (sample 5), an adhesive of refractive index N=1.52 for light of wavelength 660 nm is used as the adhesive layer of the diffractive optical element. A film of refractive indexes 1.58 with respect to an ordinary light ray and 1.67 with respect to an extraordinary light ray for light of the wavelength 660 nm is used as the film of the diffractive optical element.

In a diffractive optical element according to the sixth sample (sample 6), an adhesive of refractive index N=1.58 for light of the wavelength 660 nm is used as the adhesive layer of the diffractive optical element. A film of refractive indexes 1.58 with respect to an ordinary light ray and 1.67 with respect to an extraordinary light ray for light of the wavelength 660 nm is used as the film of the diffractive optical element. Namely, the adhesive layer and the film have the same refractive index in the sample 6. RMS (Root Mean Square) of wavefront aberration was measured for each of the samples 5 and 6 by using a measuring instrument Zygo MARK W. The following measurement results were obtained.

| | S1 N | AL N | F N | WA (λ rms) |
|---|---|---|---|---|
| sample 5 | 1.52 | 1.52 | 1.58/1.67 | 0.06-0.12 |
| sample 6 | 1.52 | 1.58 | 1.58/1.67 | 0.04-0.08 |

Here, the RMSs of the wavefront aberration have ranges as provided above in that a plurality of samples were measured for each of the two types of samples 5 and 6 and the measurement results of the samples are presented in the table.

From the measurement results, if the adhesive layer has a refractive index approximately equal to that of the film with respect to the ordinary light ray, it can be observed that the wavefront aberration is improved.

Next, a diffractive optical element according to the seventh sample (sample 7) is produced from the sample 6. Before the sample 6 is diced by means of a dicing saw, the overcoat (OC) layer of the thickness 50 μm, which is formed of an adhesive of refractive index N=1.58, is provided on a film where a diffraction grating is formed. At this time, the concave part of the diffraction grating is filled with the adhesive. Then, when the resulting product is diced by means of a dicing saw, it is possible to obtain the sample 7 of 5 mm×5 mm.

RMS of the wavefront aberration was measured for the sample 7 by using the measuring instrument Zygo MARK W. The following measurement result was obtained.

| | | | | | WA |
|---|---|---|---|---|---|
| | S1 N | AL N | F N | OC N | (λ rms) |
| sample 7 | 1.52 | 1.58 | 1.58/1.67 | 1.58 | 0.02-0.06 |

From the measurement result, if the adhesive layer has the same refractive index as the film for the ordinary light ray and the overcoat layer is further provided, it is possible to improve the wavefront aberration. However, the improved RMS of the wavefront aberration still reaches 0.06 at the upper bound thereof. Here, even if the adhesive layer of refractive index 1.52 is used in the sample 7, the same result for sample 7 is obtained.

Next, a diffractive optical element according to the eighth sample (sample 8) is produced from the sample 7. Before the sample 7 is diced by means of a dicing saw, a second substrate (S2), which is formed of a parallel flat glass BK7 of thickness 1 mm, is glued on the overcoat layer such that the overcoat layer is made plane. Then, when the resulting product is diced by means of a dicing saw, it is possible to obtain the sample 8 of 5 mm×5 mm.

RMS of the wavefront aberration was measured for the sample 8 by using the measuring instrument Zygo MARK W. The following measurement result was obtained.

| | S1 N | AL N | F N | OC N | S2 N | WA (λ rms) |
|---|---|---|---|---|---|---|
| sample 8 | 1.52 | 1.58 | 1.58/1.67 | 1.58 | 1.52 | 0.005-0.02 |

From the measurement result, if the overcoat layer is provided on the adhesive layer and the film having the same refractive index, and the second substrate is further glued on the overcoat layer such that the surface of the overcoat is made plane, it is possible to further improve the wavefront aberration. Additionally, the improved wavefront aberration achieves an RMS whose deviation is smaller.

Here, the samples 7 and 8 also have the diffraction grating that has the pitch 2 μm, the duty 50% and the depth 4 μm and is wedge-shaped with respect to a cross-section thereof. The samples 5 through 8 have diffraction efficiency of approximately 0% with respect to the polarization direction of the ordinary light ray and 35% with respect to the polarization direction of the extraordinary light ray for light of the wavelength 660 nm. Also, the samples 5 through 8 have a transmission factor of approximately 95% with respect to the polarization direction of the ordinary light ray and approximately 0% with respect to the polarization direction of the extraordinary light ray for light of the wavelength 660 nm.

A description will now be given, with reference to FIG. 4, of improvement of the wavefront aberration.

FIG. 4 is a cross-sectional view of a diffractive optical element including a first substrate 21, an adhesive layer 23, a film 25, an overcoat layer 27 and a second substrate 29.

In fabrication of the diffractive optical element, first, an adhesive is provided on the first substrate 21 so as to form the adhesive layer 23 thereon.

Whichever coating method is applied, it is impossible to form the adhesive layer 23 having a perfectly uniform thickness. FIG. 4 shows a less than uniform thickness distribution in the formed adhesive layer 23. Additionally, the film 25 also has a less than uniform thickness and a slight thickness variation therein.

For this reason, although the total thickness of the adhesive layer 23, the film 25 and the overcoat 27 is suppressed as a constant by the first and the second substrates 21 and 29, the individual layers have random variable thicknesses.

It is assumed that the adhesive layer 23 has the thickness d1 and the refractive index N1, the film 25 has the thickness d2 and the refractive index N2, and the overcoat layer 27 has the thickness d3 and the refractive index N3. These three layers have an optical thickness D as follows;
D=d1·N1+d2·N2+d3·N3.

When light is transmitted through the adhesive layer 23, the film 25 and the overcoat 27, the optical thickness D varies depending on the positions of the individual thicknesses d1, d2 and d3 through which the light is transmitted. As a result, the wavefront aberration is degraded.

Here, if the refractive index N1 of the adhesive layer 23 is equal to the refractive index N2 of the film 25, that is, N1=N2=N, the optical thickness D is transformed as follows;
D=(d1+d2)N+d3·N3.
Since variations of the optical thickness D can be suppressed in comparison with the case where the terms d1·N1 and d2·N2 move independently, it is possible to prevent degradation of the wavefront aberration.

Especially in the sample 8, since the individual layers thereof have the same refractive index with respect to polarization of the ordinary light ray, that is, N1=N2=N3=N, the optical thickness D is transformed as follows;
D=N(d1+d2+d3).

As mentioned above, the physical thickness (d1+d2+d3) is maintained at a constant by the first and the second substrates 21 and 29. As a result, it is possible to maintain the optical thickness D as a constant and considerably improve the wavefront aberration in the diffractive optical element according to the sample 8 because the sample 8 has the lower bound 0.005 of the wavefront aberration.

According to the present invention, it is possible to realize a diffractive optical element that can effectively improve the wavefront aberration. Additionally, if the film where a diffraction grating is presented in the diffractive optical element is formed of an organic material, it is possible to fabricate the diffractive optical element at a low cost.

It should be noted that the diffractive optical element is not limited to the above-mentioned materials and configurations as mentioned with respect to the embodiments of the present invention.

When an interface between the entrance and the exit surfaces and an air layer of the sample 8 is antireflection-coated for light of the wavelength 660 nm, such a diffractive optical element can be properly used as a polarization hologram element constituting an optical pickup apparatus as shown in FIG. 2. Then, when such optical pickup apparatus is incorporated in an optical disk drive apparatus as shown in FIG. 3 and this optical disk drive apparatus is used to reproduce information in a DVD (Digital Versatile Disk) serving as the optical disk 40, it is possible to obtain an extremely high-quality reproduction image.

The present invention is not limited to the specifically disclosed embodiments, and variations and modifications may be made without departing from the scope of the present invention.

The present application is based on Japanese priority application No. 2002-106444 filed Apr. 9, 2002, the entire contents of which are hereby incorporated by reference.

1-19. (canceled)

20. A diffractive optical element manufacturing method, comprising the steps of:
providing a first optically transparent substrate;
forming a first optically transparent adhesive layer on said optically transparent substrate;
forming an optically transparent film on said first optically transparent adhesive layer, wherein said optically transparent film comprises a top and bottom surface, wherein one surface is affixed to said first optically transparent adhesive layer;
forming a desired diffraction grating pattern on the opposite surface of said optically transparent film, wherein convex-concave irregularities are formed on said opposite surface of said optically transparent film;
forming a second optically transparent adhesive layer on said optically transparent film such that the second optically transparent adhesive layer fills said convex-concave irregularities of said optically transparent film; and
forming a second optically transparent substrate on said second optically transparent adhesive layer.

21. A diffractive optical element, comprising:
a first optically transparent substrate;
a first optically transparent adhesive layer formed on said first optically transparent substrate;
an optically transparent film formed on said first optically transparent adhesive layer, said optically transparent film having a surface on which a diffraction grating pattern is formed thereon, wherein said diffraction grating pattern creates convex-concave irregularities on said optically transparent film;
a second optically transparent adhesive layer formed on said optically transparent film such that the second optically transparent adhesive layer fills said convex-concave irregularities on said optically transparent film; and
a second optically transparent substrate formed on said second optically transparent adhesive layer.
